(19) United States
(12) Patent Application Publication
(10) Pub. No.: US 2003/0013568 A1
(43) Pub. Date: Jan. 16, 2003

(54) Power transmission belt

(76) Inventor: Eugeny I. Rivin, West Bloomfield, MI (US)

Correspondence Address: Eugeny I. Rivin, 4227 Foxpointe Dr., West Bloomfield, MI, 48323, US

(21) Appl. No.: 10/165,003

(22) Filed: Jun. 7, 2002

Related U.S. Application Data
(60) Provisional application No. 60/305,302, filed on Jul. 13, 2001.

(51) Int. Cl. F16G 1/00; F16G 5/00; F16G 9/00

(52) U.S. Cl. 474/237; 474/241; 474/201

(57) ABSTRACT

A construction of a power transmission belt composed of a plurality thin layers of a material strong in tension, e.g. metal, which can have a limited mobility between the adjacent layers to accommodate different kinematics of the layers located at different distances of the pulley axis. This mobility is realized without friction, by internal shear in thin elastomeric spacers between the layers constituting the belt. The power transmission rating of the disclosed belt is further enhanced by a high friction coating of the side (beveled) surfaces of the belt if it is shaped as a V-belt, or by a gripping surface conforming with the contact surface of the pulley (e.g., poly-V, timing, etc.) if it is shaped as a flat belt.

The Priority Date for this Application is requested to be Jul. 13, 2001 per Provisional Patent Application No. 60/305,302.

### FIELD OF THE INVENTION

The invention relates to the area of mechanical power transmission, and specifically to power transmission belts.

### BACKGROUND OF THE INVENTION

Belt transmissions are “work horses” of industry. Flat and poly-V belts are relatively thin and consequently provide for high speed transmissions and for multiple pulley transmissions (such as accessory drives for internal combustion engines) since they develop relatively low bending (tension-compression) stresses during bending around pulleys. However, due to their small thickness the torques transmitted by such belts are rather low. V-belts provide for higher transmitted loads than flat belt transmissions, have lower noise levels than chain transmissions, are relatively inexpensive. However, since V-belts are rather thick, and since the power transmission process involves continuous bending of the belt when it goes around pulleys, the tension-compression stresses in V-belts caused by bending are quite high, especially for small pulleys. As a result, the radii of the pulleys cannot be made as small as for flat belt drives, the belt speed is limited, and energy losses are significant (thus the belt drive efficiency is lower than desirable) due to hysteretic losses during cyclical bending and due to friction losses in the contact areas between the rubber belt and the pulleys.

The variable ratio V-belt power transmission is the simplest and, possibly, the most reliable mechanical variable speed transmission. However, since it employs a relatively thick rubber V-belt, its operation is accompanied by high friction losses between the belt edges and the metal pulleys, as well as by high losses due to continuous cyclical bending. In addition, the rated torque is limited by fatigue strength of the rubber belt. Due to these reasons, the V-belt variable transmissions are not used for such critical applications as automotive CVTs (constantly variable transmissions) since a successful CVT must have high efficiency as well as high power density and long life.

Due to the mentioned above advantages of the V-belts for constant and variable transmission ratio transmissions and to disadvantages of using thick rubber belts, the known successful applications of such transmissions for CVTs involve using specially designed metal chains instead of belts.

One design (by Van Dorn Co.) is using the chain assembled from multiple transverse laminations, which transmits the driving force by pushing action, rather than by pulling action as in the drives with conventional rubber V-belts. The torque/power transmitting capability is limited and it is used only in some mini cars. The chain comprises numerous components and is quite expensive.

Another design (by LuK Co.) involves a “pulling” chain carrying pins in each link defining a “virtual V-belt”. The beveled pin ends are interacting with the tapered pulleys. Such design is capable to accommodate higher torque/power ratings. However, the LuK chain is even more expensive than the Van Dorn chain and it has such problems as very high contact stresses between the pins and the pulleys and high noise/vibration levels typical for articulated chains and further exacerbated by periodic mini impacts of the multiple pins against the pulley surfaces during the chain-pulley engagement process.

U.S. Pat. No. 4,698,050, FIGS. 1, 2, and 3 (Prior Art), discloses a combination design of a V-belt comprised of endless laminated metallic belt 1 in FIGS. 1 and 4 in FIGS. 2 and 3, assembled from endless metal rings 4a to 4n made from thin metal band and inserted into each other and frictionally attached to trapezoidal metal blocks 5, which are in their turn movably engaged with pulleys 2 and 3. Thus, the tensile (tangential to the pulleys) forces are transmitted by strong and flexible metal belt while engagement with the pulleys is accomplished through the V-shaped blocks. While such a design reduces some shortcomings of conventional V-belt drives, it has several shortcomings of its own. Since each metal band 4a-4n constituting laminated belt 4 in FIGS. 2, 3 has different distance from the axis of the pulley while negotiating the pulley, the circumferential velocity of each band is different thus resulting in small slippages between the laminations/rings. Since these slippages develop under high normal forces, they develop fretting corrosion and wear. Reduction of wear requires special expensive treatments of the bands disclosed in U.S. Pat. No. 4,698,050 and or expensive modifications in band ring designs, e.g. as disclosed in U.S. Pat. No. 6,090,004. The discrete engagement of the metal blocks with the pulleys results in inevitable nonuniformity of motion and noise and dynamic loads, similar to such undesirable effects in chain drives, especially for small diameter pulleys.

The proposed design of the flat and V-belt for both constant and variable ratio transmissions is free from disadvantages of the prior art designs.

### SUMMARY OF THE INVENTION

The present invention provides a design of a power transmission belt which combines high-speed and multi-pulley capabilities of flat and poly-V belts with high power density of V-belts, is free from disadvantages of the prior art addressed above while retaining generic advantages of constant and variable transmission ratio belt drives.

The present invention discloses a design of a power transmission belt in which intensity of tension-compression stresses caused by bending is diminished, even when small diameter pulleys are used, while payload capacity can be greatly enhanced.

The torque and motion transmission is uniform, without generating dynamic loads and noise.

The present invention does not require assembly of the power transmission belt from numerous fabricated components, thus combining high performance with reasonable costs.

The present invention achieves these and other advantageous results by disclosing a belt design wherein a belt of a required thickness comprises a multitude of thin layers with the adjacent layers having a relative mobility without friction thus allowing compensation for different kinematic conditions of each layer when the belt negotiates a pulley without causing fretting corrosion and wear.

### BRIEF DESCRIPTION OF THE DRAWINGS

The present invention can best be understood with reference to the following detailed description and drawings, in which:

FIG. 1 is a general schematic side view of the prior art belt transmission with laminated metallic belt.

FIG. 2 is a sectional view of the prior art endless metallic belt.

FIG. 3 is a sectional view along line III-III of prior art in FIG. 2.

FIG. 4 shows a cross section, by a plane containing axes of the pulleys, of the disclosed power transmission belt embodied as a V-belt with the relative mobility between the adjacent bands achieved through internal shear of elastomeric spacers.

FIG. 5 shows a cross section of the drawing in FIG. 1 by the plane A-A as indicated in FIG. 1.

FIG. 6 shows a flat belt transmission employing the disclosed belt design concept.

### DETAILED DESCRIPTION OF THE PREFERRED EMBODIMENTS

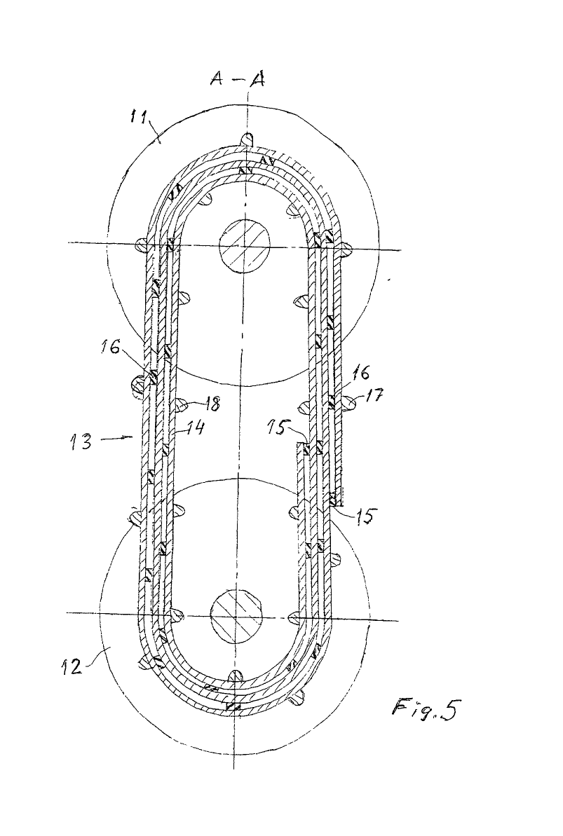

The preferred embodiment is shown in FIGS. 4, 5. The transmission (a constant ratio V-belt transmission is shown) has two pulleys 11, 12 between which belt 13 is positioned. Belt 13 is constructed from several layers 14 of a thin band made of a material of high rigidity in tension, such as metal (e.g., steel strip 0.001-0.003 in. thick); plastic, both uniform and fiber-reinforced (preferably, with longitudinally placed fibers); etc. Thin commercially available flat belting materials can also be used as the band materials. Each constitutive layer 14 of belt 13 can be an endless (close loop/ring) band, with each layer having an incrementally larger (by ˜2π) circumferential length than the adjacent layer closer to the interior of the belt, where t is the distance between the central surfaces of the layers. In another embodiment (as shown in FIGS. 4, 5) the band is wrapped, initially preferably with the constant curvature radius (e.g., on a round mandrel) so that the length (circumference) of the interior surface of the belt represents its required length. The inner (trailing) and the outer (leading) ends of the band are attached to the adjacent layers of the belt as shown. The attachments can be made rigidly, e.g., by welding, soldering, gluing, etc., but preferably in a flexible way, e.g. by thin elastomeric (rubber) inserts 15 bonded to both connected layers, as shown in FIG. 5.

There are minor relative movements between the adjacent band layers caused by their different distances from the axes of the pulleys. If these movements, which develop while the adjacent layers are loaded with high forces transmitted by the belt, are accommodated by friction between the layers, then fretting corrosion, wear, and motion inconsistencies would ensue. The preferred method of accommodating these minor motions would be elimination of the inter-layer friction.

An embodiment allowing elimination of friction is shown in FIGS. 4, 5 wherein thin elastomeric (rubber) inserts 15 and 16 are inserted between and, preferably, bonded to the adjacent layers of the wrapped band. It is known that thin sheets of rubber materials can safely accommodate huge compression loads, up to and exceeding 40-50,000 psi, without significant deformations while their shear resistance is very low and is not affected by the compression loads contrary to friction wherein the friction force is proportional to the compression load on the connection. These properties of thin rubber layers are described, e.g., in Rivin, E. I., “Stiffness and Damping in Mechanical Design”, Marcel Dekker, 1999, pp. 444-452. Accordingly, thin rubber inserts 15, 16 (whose thickness is usually commensurate with thickness of the band 14 from which the belt is made) can be made relatively narrow and still easily accommodate high compression forces acting between the band layers, while the narrow width results in a low shear resistance of the inserts and thus, in easy mobility between the band layers.

The final shape of the belt used as a V-belt is as shown in FIG. 4, wherein the side surfaces of belt 13 are beveled to the angle corresponding to the inclination angle of the contact surfaces of pulleys 11, 12. This beveling can be achieved either by pre-shaping the band into an oblong triangular shape before the wrapping procedure, so that a symmetrical wrapping would result in the desired shape of belt 13, or by machining the side surfaces after the belt is produced, or by any other production technique.

The power transmission rating of the shown V-belt can be significantly enhanced and/or pretension of the belt reduced if the band edges forming the beveled side surfaces contacting the pulley surfaces are coated with a high friction coating. Any known high friction coating can be used, such as a thin plastic or elastomer layer, a hard coating such as titanium nitride (TIN), etc.

Since the metal or plastic band may have very high tensile strength, thin belt 13 may accommodate very high driving forces. In order to increase stability of belt 13 under high forces between the side surfaces of the belt and the contact surfaces of the pulleys, the width of the belt can be reduced since its power transmission rating is very high. Also, the power transmission rating can be enhanced by using more layers, thus compensating for the reduced width. To further enhance stability and to enhance the friction interaction between the belt and the pulleys, stabilizing elements (bars) 17, 18 made of a metal or a plastic can be attached to the outer (17) and/or to the inner (18) surfaces of belt 13. These bars are fastened to the surface(s) of the belt and have their sides shaped as a continuation of the beveled surfaces of belt 13.

In operation, since belt 13 is composed of thin bands rigid and strong in tension, thus allowing transmission of high tangential (driving, tensile) forces but very flexible in bending, the cyclical bending of the belt while in contact with one of the pulley does not induce high stresses, since each layer is bending independently from other layers. This independence is further enhanced if the layers do not rub against each other but are separated by thin flexible elastomeric inserts 15, 16, accommodating these movements by internal shear. If high torques are needed to be transmitted, then the proper materials for band 14, which can take very high contact forces (such as tempered or hardened steel) or the proper edge coatings as addressed above, can be used. The torque transmission can be further enhanced by adding elements 17, 18 whose interactions with the pulleys are along small areas and do not induce significant sliding friction or impacts. The transmitted tensile forces can be much higher than in a chain whose tensile strength is limited by pivots, thus the proposed belt may be made narrower and thinner/lighter than the chain (or a rubber belt). The narrow belt is stable even with a smaller thickness, thus allowing for smaller diameter pulleys, for higher speeds, and for smaller size drives. The continuous structure of the belt, as opposed to the chains, results in a lower noise generation.

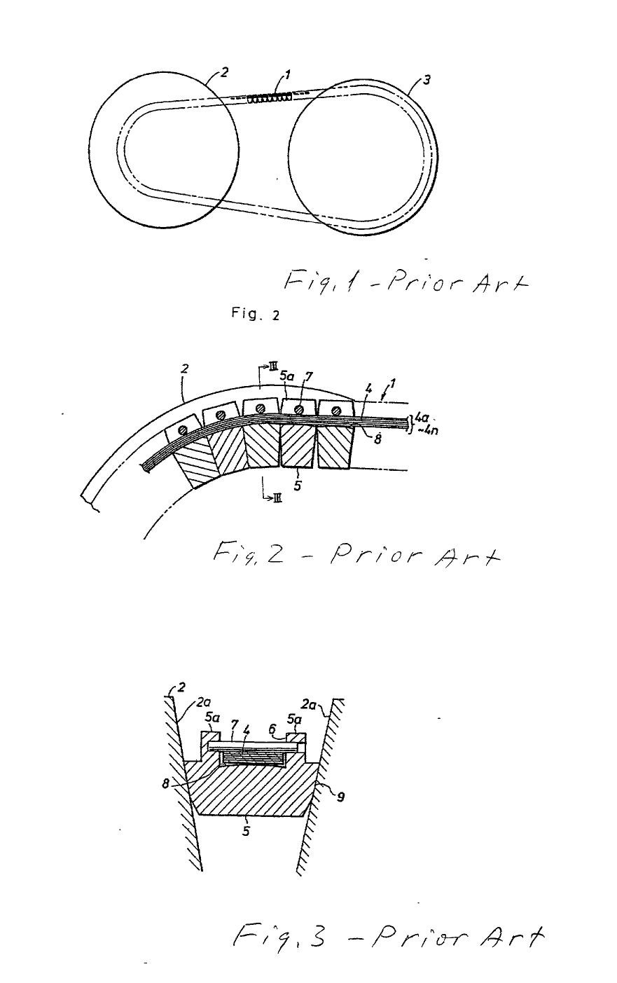

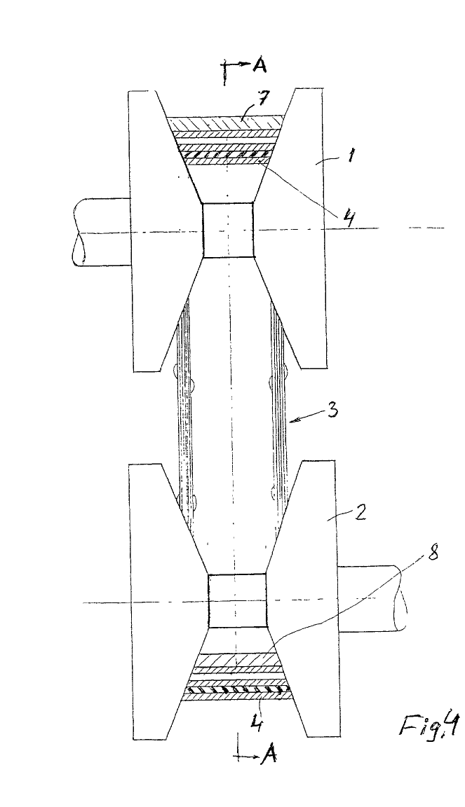

The preferred embodiment shown in FIGS. 4, 5 involves direct engagement between the belt and the pulleys. However, the total elimination of friction between the bands constituting the belt by using internal shear in the elastomeric inserts (spacers) between the band layers to compensate for their kinematic differences, can be beneficially used also in the laminated metal belts used in the prior art designs like one shown in FIGS. 1-3. In these designs the belt is engaged with the pulleys indirectly, but via shaped blocks.

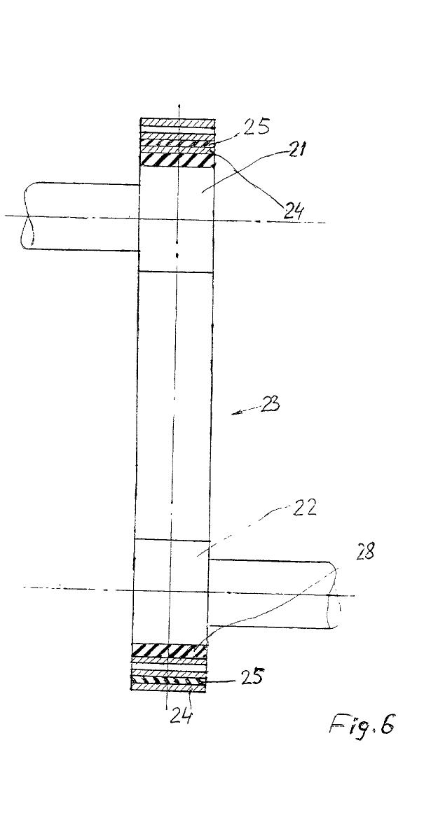

In FIG. 6 pulleys 21 and 22 are connected by flat belt 23 comprising wrapped thin band 24 whose layers are separated by elastomeric inserts 25. The inner surface of belt 23 which is in contact with pulleys 21 and 22 has elastomeric, leather, or other high friction lining 28 for a better grip with the pulleys. While flat gripping layer 28 is shown, it can be shaped as “poly-V” or as timing belt-like toothed layer.

It is readily apparent that the components of the power transmission belt design disclosed herein may take a variety of configurations. Thus, the embodiments and exemplifications shown and described herein are meant for illustrative purposes only and are not intended to limit the scope of the present invention, the true scope of which is limited solely by the claims appended thereto.

1. A power transmission belt adapted to be arrayed over a pair of pulleys supported for rotation about spaced parallel axes so as to transfer rotational motion of one of the pulleys to the other pulley; said belt comprising a plurality of thin bands of material having a relatively high tensile strength lying parallel to said axes, the bands overlying one another, and elastomeric spacers disposable between the bands, so that the bands share the tensile forces exerted between the pulleys with each band bending independently as the belt engages each rotating pulley, the elastomeric spacers allowing relative motion between the bands in the plane of the bands.

2. The belt of claim 1, wherein said bands comprise independent close loops.

3. The belt of claim 1, wherein the bands are formed by a continuous length of band material wrapped upon itself, with the leading and the trailing ends of the band material being fastened to the closest surfaces of the wrapped band material via elastomeric inserts bonded to said leading and trailing ends and to the previous band layers.

4. The belt of claim 1 wherein said elastomeric inserts having thickness commensurate with thickness of said band material and placed between the adjacent layers of said band.

5. The belt of claim 1 wherein each said elastomeric insert is bonded to at least one of the contacting bands

6. The belt of claim 1 wherein the bands are formed from metal.

7. The belt of claim 1 wherein said bands are formed from a fiber-reinforced material.

8. The belt of claim 1 wherein side surfaces of the belt are beveled in order to form a V-belt cross section conforming with contact surfaces of tapered pulleys.

9. The belt of claim 9 wherein a high friction material is applied to said side beveled surfaces.

10. The belt of claim 1 wherein a gripping layer conforming to the contact surface of the pulley is attached to the surface of the belt interacting with said pulley.

11. The belt of claim 11 wherein said gripping layer has a smooth contact surface with high friction coefficient between said gripping layer and said contact surface of the pulley.

12. The belt of claim 11 wherein said gripping layer has a poly-V shaped cross section.

13. The belt of claim 11 wherein said gripping layer has a toothed contact surface.

14. The belt of claim 1 having inner and outer surfaces, wherein stabilizing bars are attached to at least one of said surfaces.

15. The belt of claim 1 wherein said bands transmit rotational motion by directly engaging with said pulleys.

16. The belt of claim 1 wherein said bands are attached to intermediate elements having contact surfaces conforming with contact surfaces of said pulleys and transmitting driving forces between said pulleys and said belt.
